(19) United States
(12) Patent Application Publication
(10) Pub. No.: US 2014/0204203 A1
(43) Pub. Date: Jul. 24, 2014

(54) Reflectometer, spectrophotometer, ellipsometer or polarimeter system including sample imaging system that simultaneously meets scheimpflug condition and overcomes keystone error

(71) Applicants: Martin M. Lihardt, Lincoln, NE (US); Ping He, Lincoln, NE (US)

(72) Inventors: Martin M. Lihardt, Lincoln, NE (US); Ping He, Lincoln, NE (US)

(73) Assignee: J. A. WOOLLAM CO., INC., Lincoln, NE (US)

(21) Appl. No.: 13/815,625

(22) Filed: Mar. 13, 2013

Related U.S. Application Data
(60) Provisional application No. 61/849,178, filed on Jan. 22, 2013.

(51) Int. Cl. G01N 21/17

(52) U.S. Cl. CPC G01N 21/17
USPC 348/128

(57) ABSTRACT

An imaging system, and method of its use, for viewing a sample surface at an inclined angle, preferably in functional combination with a sample investigating reflectometer, spectrophotometer, ellipsometer or polarimeter system; wherein the imaging system provides that a sample surface and multi-element imaging detector surface are oriented with respect to one another to meet the Scheimpflug condition, and wherein a telecentric lens system is simultaneously positioned between the sample surface and the input surface of the multi-element imaging detector such that an image of the sample surface produced by said multi-element imaging detector is both substantially in focus over the extent thereof, and such that substantially no keystone error is demonstrated in said image.

This application Claims Benefit of 61/849,178 Filed Jan. 22, 2013.

### TECHNICAL FIELD

The present invention relates to reflectometers, spectrophotometers, ellipsometers and polarimeters, and more particularly to a reflectometer, spectrophotometer, ellipsometer or polarimeter system wherein an investigated sample surface and detector surface are oriented with respect to one another to meet the Scheimpflug condition, and wherein a telecentric lens system is simultaneously positioned between said sample surface and the input surface of said detector such that an image of said sample surface produced by said detector is both substantially in focus over the extent thereof, and such that substantially no keystone error is demonstrated in said image.

### BACKGROUND

It is known to investigate surfaces of samples using beams of electromagnetic radiation, as in reflectometry, ellipsometry, polarimetry and spectrophotography. However, a problem that has recently been noted involves monitoring a surface of a sample in a manner that maintains an image thereof in focus over the extent thereof, and which simultaneously compensates for Keystone error in said image.

It is known to orient sample surfaces and detector input surfaces so that the Scheimpflug condition is met so as to attain focus of a sample surface image over the extent thereof, and it is known to apply Telecentric lens systems to compensate for keystone error. However, in the context of reflectometers, spectrophotometers, ellipsometers and polarimeters it is believed new, novel and non-obvious to simultaneously both meet the Scheimpflug condition by properly orienting sample and detector input surfaces with respect to one another, and to simultaneously apply a telecentric lens system between said sample surface and detector surface to compensate Keystone error.

A computer search for patents that including the Terms “Scheimpflug and Reflectometer” has identified U.S. Pat. Nos. 7,872,751 and 7,567,345. And a similar computer search for patents containing the terms “Telecentric and Reflectometer provided U.S. Pat. Nos. 8,160,351, 7,898,661, 7,859,659, 7,777,878, 7,719,677, 7,656,519, 7,477,372, 7,460,248, 7,190,460, 7,084,967, 7,075,637, 6,888,627, 6,862,090, 6,832,843, 6,636,302, 6,437,312, 6,370,422, 5,094,523 and 4,660,984. No overlap in said two searches is identified.

A search for patents that including the Terms “Scheimpflug and Spectrophotometer” has identified U.S. Pat. Nos. 7,872,751, RE41,906, 7,653,428, RE40,225, 7,107,092, RE38,153, 5,874,455, 5,764,365, 5,665,770, 5,517,312 and 4,895,445. And, a search for patent containing the terms “Telecentric and Spectrophotometer provided 8,218,152, 8,194,283, 8,189,170, 8,149,381, 8,008,642, 7,993,613, 7,957,067, 7,898,912, 7,897,912, 7,859,659, 7,800,014, 7,777,878, 7,723,662, 7,698,068, 7,697,111, 7,652,792, 7,583,386, 7,428,056, 7,408,649, 7,352,459, 7,336,354, 7,166,163, 7,113,281, 7,086,863, 6,922,236, 6,895,158, 6,850,371, 6,835,683, 6,832,824, 6,765,724, 6,672,109, 6,649,268, 6,687,262, 6,153,873, 6,108,083, 6,008,905, 5,812,419, 5,680,209 and 3,972,627. Again, there is no overlap in the identified searches.

A computer search for patents including the Terms “Polarimeter and Telecentric” has identified U.S. Pat. Nos. 8,160,351, 7,777,878, 7,221,420, 7,079,247, 7,061,561, 7,038,776 and 6,927,888. A computer search for patents including the Terms “Polarimeter and Scheimpflug” has identified U.S. Pat. Nos. 7,872,751 and 7,567,345. It is noted that there is no overlap in the two identified searches.

Similarly a computer search for patents including the Terms “Ellipsometer and Telecentric” has identified U.S. Pat. Nos. 8,175,831, 8,111,376, 8,054,467, 7,898,661, 7,864,296, 7,859,659, 7,791,732, 7,777,878, 7,719,677, 7,636,168, 7,583,386, 7,428,056, 7,408,649, RE39,978, 7,221,420, 7,190,460, 7,151,609, 7,061,561, 6,879,380 6,862,090, 6,737,207, 6,592,574, 6,583,877, 6,525,806, 6,507,441, 6,493,097, 6,323,946, 6,177,990, 6,008,892, 5,917,594 and 5,646,733. Whereas a search for the patents including the Terms “Ellipsometer and Scheimpflug” provided U.S. Pat. Nos. 7,872,751, RE41,906, 7,724,362, 7,567,345, RE40,225, 6,592,574, RE38,153, 5,963,326, 5,764,365 and 5,517,312. Again, but for the patent No. 6,592,574, no overlap is identified in the two searches except for the U.S. Pat. No. 6,592,574, and this patent does not suggest a combined Scheimpflug and telecentric system, but rather suggests using said systems separately in different embodiments of a system for laser sculpting of eye tissue.

In addition, patents to Liphardt et al., U.S. Pat. Nos. 7,567,345, 7,872,751 and 8,013,966 are identified as they discuss the Scheimpflug condition referenced to a detector in an system that uses electromagnetic radiation to investigate a sample, that describe additional alignment or imaging systems above a sample in addition to sample investigating elements and that describe a spatial filter.

Another patent to Liphardt, U.S. Pat. No. 8,345,241 is identified as it mentions both the Scheimpflug condition, and Telecentric imaging in an ellipsometer system that includes a digital light processor.

In view of the foregoing, a need for a system selected from the group of reflectometer, ellipsometer, polarimeter and spectrophotometer, is therefore identified, which system simultaneously provides benefits inherent in meeting the Scheimpflug condition between a sample surface and a detector surface, and in applying a telecentric lens system, is identified.

### DISCLOSURE OF THE INVENTION

The present invention is an imaging system for viewing a sample at an inclined angle comprising:

a) a source of illuminating electromagnetic radiation;

b) an optional collimator;

c) a stage for supporting a sample placed thereupon;

d) a telecentric lens system; and

e) a multi-element imaging detector having an input surface.

The system is distinguished in that said stage and multi-element imaging detector are oriented with respect to one another such that the surface of said sample placed on said stage and the input surface of said detector meet the Scheimpflug condition, and said telecentric lens system is simultaneously positioned between said sample surface and the input surface of said multi-element imaging detector such that an image of said sample surface produced by said detector is both substantially in focus, and such that substantially no keystone error is demonstrated in said image.

Said imaging system for viewing a sample at an inclined angle an further comprises a computer for receiving data from said multi-element imaging detector and correcting it for image aspect ratio.

Said imaging system for viewing a sample at an inclined angle can further comprise at least one polarizer between said source of illuminating electromagnetic radiation and said multi-element imaging detector to enable effecting a polarization state in a beam of electromagnetic radiation produced by said source thereof, and can also further comprise at least one compensator between said source of illuminating electromagnetic radiation and said detector to further enable effecting a polarization state in a beam of electromagnetic radiation produced by said source thereof.

Said imaging system for viewing a sample at an inclined angle provides that said telecentric lens system can comprise, in sequence:
a lens;
an aperture having a diameter; and
a lens;
   and said aperture diameter can be adjustable.

As a result of the present invention system configuration making space available, said system for viewing a sample at an inclined angle can further comprises a second imaging, or metrology system positioned substantially above said sample surface and between said source of a beam of electromagnetic radiation and said multi-element imaging detector having an input surface.

During use, illuminating electromagnetic radiation provided by that source thereof can approaches the sample surface along an oblique angle, which can be at, or near the Brewster angle for the sample being investigated.

A modified system, comprises an imaging system for viewing a sample at an inclined angle, in functional combination with a reflectometer, spectrophotometer, ellipsometer or polarimeter system.

In said modified imaging system for viewing a sample at an inclined angle, the imaging system comprises:

a) a source of illuminating electromagnetic radiation;

b) an optional collimator;

c) a stage for supporting a sample placed thereupon;

d) a telecentric lens system; and

e) a multi-element imaging detector having an input surface.

As before, said stage and multi-element imaging detector are oriented with respect to one another such that the surface of said sample placed on said stage and the input surface of said multi-element imaging detector meet the Scheimpflug condition, and said telecentric lens system is simultaneously positioned between said sample surface and the input surface of said multi-element imaging detector such that an image of said sample surface produced by said multi-element imaging detector is both substantially in focus, and such that substantially no keystone error is demonstrated in said image. In use said source of illuminating electromagnetic radiation provides illumination to a spot on a sample placed on said stage for supporting a sample placed thereupon.
In said modified system, the reflectometer, spectrophotometer, ellipsometer or polarimeter system comprises:
a source of a sample investigating beam of electromagnetic radiation;
a stage for supporting a sample placed thereupon; and
a detector.

In use, said reflectometer, spectrophotometer, ellipsometer or polarimeter system is oriented to provide a sample investigating beam of electromagnetic radiation to said sample placed on said stage for supporting a sample, so that it impinges on a spot thereof which is substantially coincident with illuminating electromagnetic radiation provided by said source of illuminating electromagnetic radiation.

It is noted that said source of illuminating electromagnetic radiation and said source of a sample investigating beam of electromagnetic radiation can both be derived from a single primary source via a beam splitter.

It is noted that addition of a polarizer between the source of a sample investigating beam of electromagnetic radiation and said stage for supporting a sample placed thereupon; and an analyzer between said stage for supporting a sample placed thereupon and said detector, respectively, provides an ellipsometer system. And further addition of a compensator between said source of a sample investigating beam of electromagnetic radiation and said detector enables operation as a polarimeter.

As before, said system can further comprise a computer for receiving data from said multi-element imaging detector and correcting it for image aspect ratio that arises because the sample surface is approached by the illuminating electromagnetic radiation at an inclined angle.

As before, said modified system can further comprise at least one polarizer and/or at least compensator between said source of illuminating electromagnetic radiation and said detector to enable effecting a polarization state in said illuminating electromagnetic radiation produced by said source thereof.

Again, as before, said modified system can provide that the telecentric lens system comprises, in sequence:
a lens;
an aperture having a diameter; and
a lens;
   and said aperture diameter can be adjustable.

And, again, as room therefore exists in the present invention system, said modified system for viewing a sample at an inclined angle can further comprise a second imaging, or metrology, system positioned substantially above said sample surface and between said source of a beam of electromagnetic radiation and said detector having an input surface.

During use, said system for viewing a sample at an inclined angle can again provide that illuminating electromagnetic radiation provided by source thereof approaches the sample surface along an oblique angle, which can be at, or near the Brewster angle for the sample being investigated.

A method of investigating a sample with an electromagnetic beam comprises the steps of:
providing an imaging system for viewing a sample at an Inclined angle comprising:
a) a source of illuminating electromagnetic radiation;
b) an optional collimator;
c) a stage for supporting a sample placed thereupon;
d) a telecentric lens system; and
e) a multi-element imaging detector having an input surface.
   Said stage and detector are oriented with respect to one another such that the surface of said sample placed on said stage and the input surface of said multi-element imaging detector meet the Scheimpflug condition, and said telecentric lens system is simultaneously positioned between said sample surface and the input surface of said multi-element imaging detector such that an image of said sample surface produced by said multi-element imaging detector is both substantially in focus, and such that substantially no keystone error is demonstrated in said image.
   Said method then further comprises steps b), c) and d):

b) orienting said sample surface and multi-element imaging detector surface to meet the Scheimpflug condition and positioning said telecentric lens system between said sample surface and multi-element imaging detector surface so that, in an image of said sample surface when produced by said multi-element imaging detector, demonstrates substantially no keystone error and said image is substantially in focus over its entire extent;

c) causing said source of illuminating electromagnetic radiation to direct illuminating electromagnetic radiation to optionally interact with said collimator then proceed to reflect from said sample surface, pass through said telecentric lens system and enter said multi-element imaging detector;

d) causing said multi-element detector to produce an image of said sample surface that is substantially free of keystone error and is substantially in focus.

Said method can also involve providing a reflectometer, spectrophotometer, ellipsometer or polarimeter system comprising:
a source of a sample investigating beam of electromagnetic radiation;
a stage for supporting a sample placed thereupon; and
a detector of said sample investigating beam of electromagnetic radiation.
   When so provided, the method further provides that steps e) and f) are further practiced, said steps e) and f) being;

e) while, or after practicing steps c) and d) to provide an image of he sample, causing said source of a sample investigating beam of electromagnetic radiation to direct a sample investigating beam of electromagnetic radiation toward said sample such that it passes through said polarizer, impinges on said sample at a location substantially coincident with said illuminating electromagnetic radiation provided by said source of illuminating electromagnetic radiation, reflects therefrom, passes through said analyzer; and

f) said detector of said sample investigating beam of electromagnetic radiation receiving the sample investigating electromagnetic radiation reflected from said sample, and producing sample characterizing data.

It is to be understood that the methodology can be carried out under the control of a computer and/or the methodology can include storing at least some output provided by the detector in a non-transitory maching readable media and analyzing at least some output provided by the detector.

The present invention will be better understood by reference to the Detailed Description Section, in conjunction with the Drawings.

### BRIEF DESCRIPTION OF THE DRAWINGS

FIG. 1 shows a general system for illuminating the surface of a sample (SA) with illuminating electromagnetic radiation (EM) provided by a source (S) thereof.

FIG. 2a shows the system of FIG. 1, with, and additionally the presence of a reflectometer, spectrophotometer, ellipsometer or polarimeter system having a source (ES) of a beam of sample investigating electromagnetic radiation, and a detector (DET) thereof.

FIG. 2b shows that the source (S) of illuminating electromagnetic radiation (EM) and the source (ES) of a beam of sample investigating electromagnetic radiation, can be derived from a single primary source (PS) of electromagnetic radiation, via a beam splitter (BS).

FIGS. 3 and 4 provides a schematic presentation of an imaging system (IMG), with a multi-element imaging detector (DET) and sample (SA) oriented to so that the surface of the sample (SA) and the surface of the multi-element imaging detector (DET) meet the Scheimpflug condition.

FIGS. 5a and 5b demonstrate the presence of, and absence of Keystone error.

FIG. 6 shows a sample (SA) and a multi-element imaging detector (DET) oriented to meet the Scheimpflug condition.

FIG. 7 is included to show tht a computer (CMP) can be applied to control the method steps of the present invention.

### DETAILED DESCRIPTION

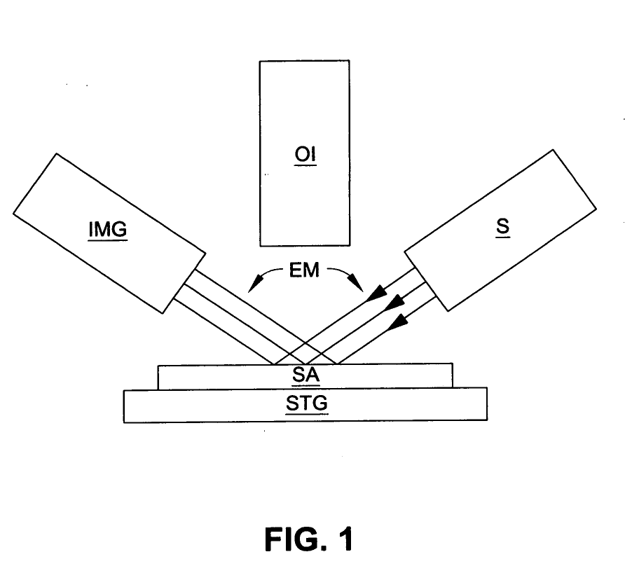

Turning now to the Drawings, there is shown in FIG. 1 a general system for illuminating the surface of a sample (SA) with illuminating electromagnetic radiation (EM) provided by a source (S) thereof. Note that the illuminating electromagnetic radiation (EM) reflects from said surface of the sample (SA) and into a imaging system (IMG) that typically is a multi-element imaging detector.

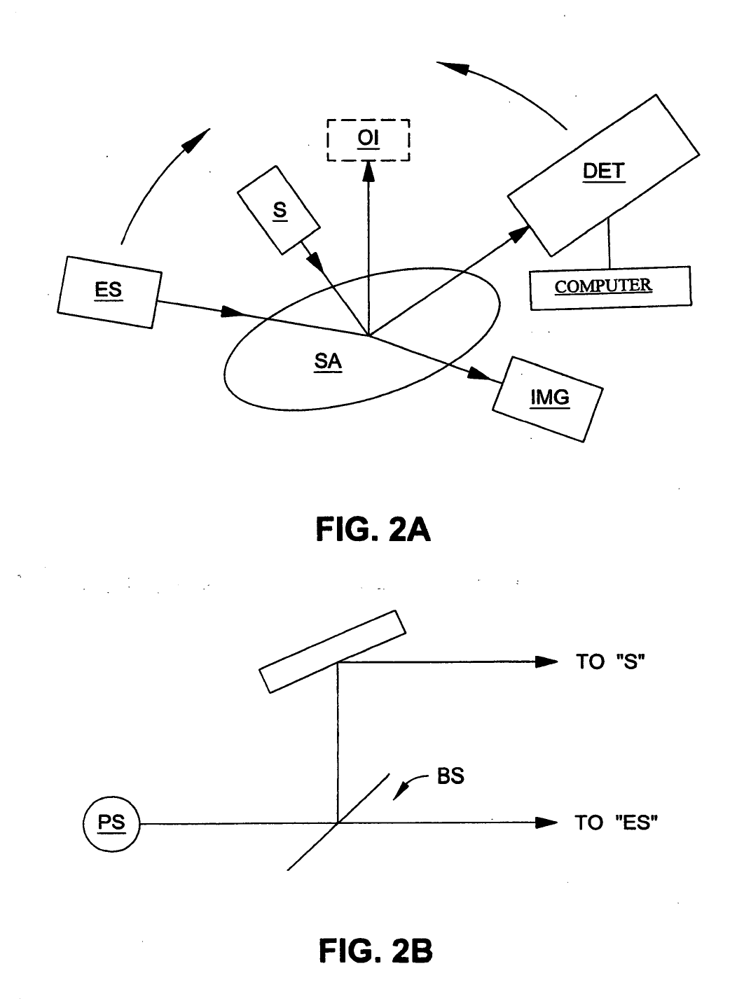

FIG. 2a shows an additional view of the FIG. 1 system for illuminating a sample surface, along with the addition of a reflectometer, spectrophotometer, ellipsometer or polarimeter system having a source (ES) of a beam of sample investigating electromagnetic radiation and a detector (DET) thereof. Also note that there is room directly above the sample (SA) for additional metrology or imaging systems (OI) even when the shown reflectometer, spectrophotometer, ellipsometer or polarimeter system is present. Also shown is a COMPUTER for analysis/control.

FIG. 2b is included to show that the source (S) of illuminating electromagnetic radiation (EM) and the source (ES) of a beam of sample investigating electromagnetic radiation, can both be derived from a single primary source (PS) of electromagnetic radiation, via a beam splitter (BS).

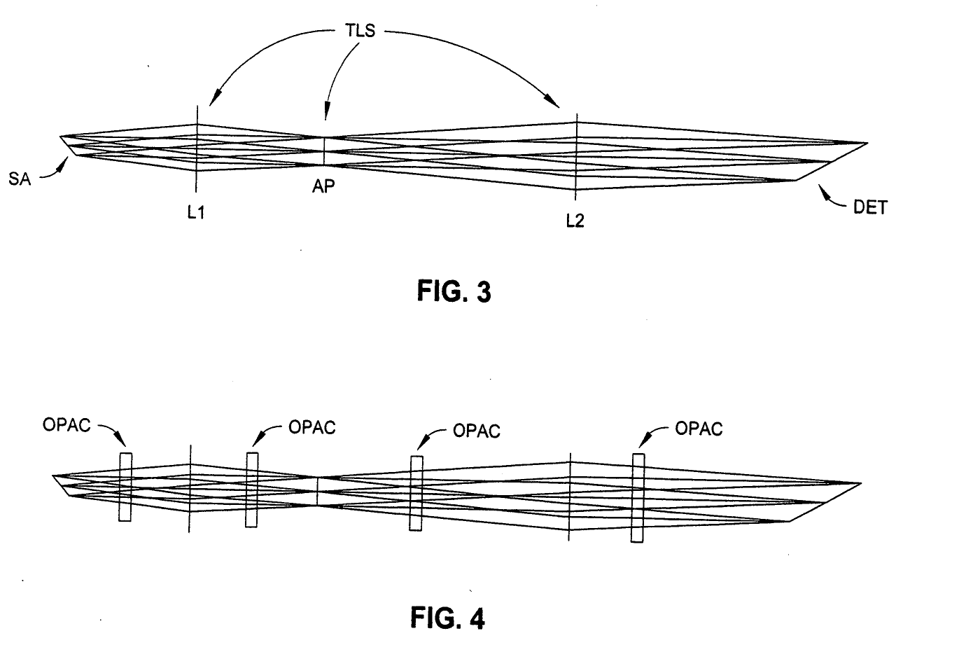

FIG. 3 provides a schematic presentation of an imaging system (IMG), with a multi-element imaging detector (DET) and sample (SA) oriented to so that the surface of the sample (SA) and the surface of the multi-element imaging detector (DET) meet the Scheimpflug condition. In addition, a Telecentric lens system (TLS) comprised of two lenses (L1) (L2) with an aperture (AP). therebetween is present between the source (S) and detector (DET). Note the sample (SA) is shown at an angle to normal, as is the detector (DET). This arrangement is what serves to meet the Scheimpflug condition and provides an image of the sample (SA) to the multi-element imaging detector (DET) that is in focus over the surface extent of said sample (SA). It is to be appreciated that the imaging system (IMG) of FIG. 2a corresponds to the more detailed presentation of its components in FIG. 3. Also note that if the sample (SA) in FIG. 3 were oriented to project in a horizontal plane, then the detector (DET) would be projected at an oblique angle thereto, as in FIG. 2a. The imaging system (IMG) of FIG. 2a should be understood to be comprised of the sequential telecentric lens system (TLS) elements and the detector (DET). (It is noted that telecentric lens system is characterized in that the entry and/or exit pupil is at infinity, where “pupil” refers to the object and/or image of an aperture).

FIG. 4 is included as it indicates that at least one optional Polarizer/Analyzer (OPAC) can be present at a location between the source (S) and detector (DET). Further, at least one Compensator (OPAC) could also be present at any of the shown locations. When present said Polarizer/Analyzer or Compensator serve to impose a polarization state on the illuminating electromagnetic radiation, which in certain circumstances can serve to improve the image of the sample surface provided by the detector (IMG).

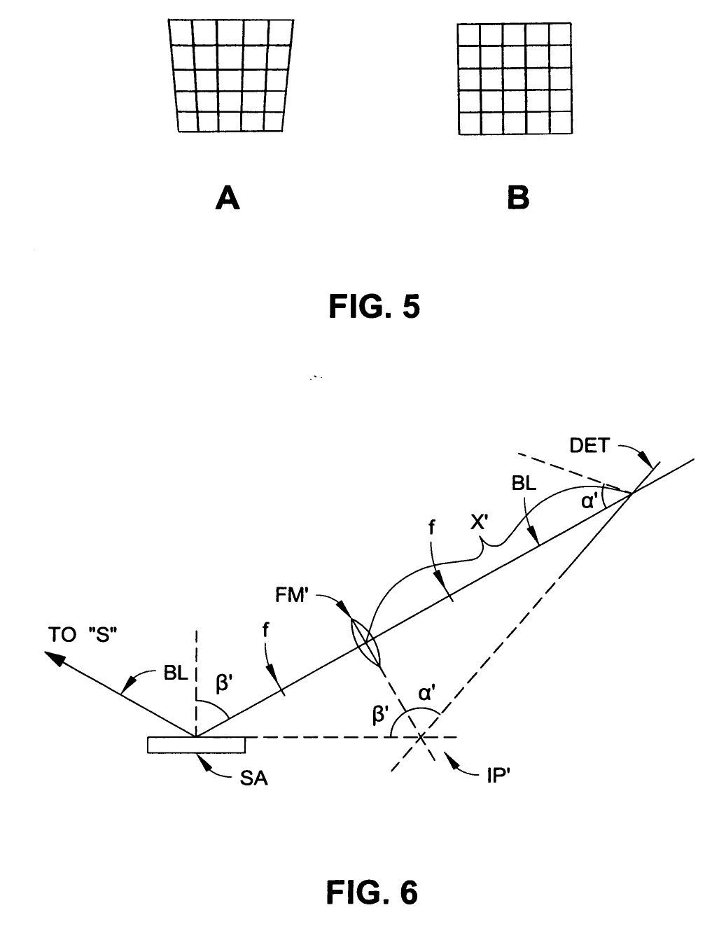

Note that it is the meeting of the Scheimpflug condition that effects the in-focus image of the sample (SA) surface at the multi-element imaging detector (DET) surface, and it is the presence of the telecentric lens system (TLS) that overcomes what is known as the “Keystone” error as demonstrated by FIGS. 5a and 5b.

FIG. 5a includes distortion of a grid that constitutes the Keystone error. FIG. 5b shows that the telecentric lens system (TLS) eliminates distortion.

FIG. 6 shows a sample surface (SA) and a multi-element imaging detector (IMG) surface oriented to meet the Scheimpflug condition which requires:

Tan(∝′)=(X′−f)/f Tan(β′);

where (X′), (f), (∝′) and (β′) are shown.

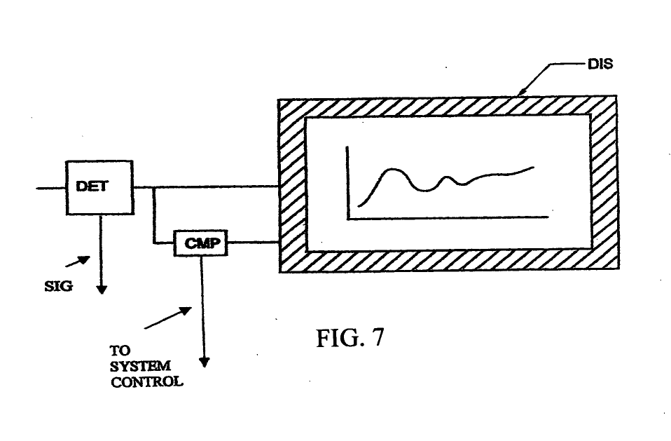

FIG. 7 is included to show tht a computer (CMP) can be applied to control the method steps of the present invention. Note, a signal (SIG) from the Detector (DET) can also be directed to said Computer (CMP), or another computer to analyze data and provide data or analyzed data output.

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breadth and scope only by the Claims.

I claim:

1. An imaging system for viewing a sample at an inclined angle comprising:
a) a source of illuminating electromagnetic radiation;
b) a stage for supporting a sample placed thereupon;
c) a telecentric lens system; and
d) a multi-element imaging detector having an input surface;
said stage and detector being oriented with respect to one another such that the surface of said sample placed on said stage and the input surface of said multi-element imaging detector meet the Scheimpflug condition, and said telecentric lens system is simultaneously positioned between said sample surface and the input surface of said multi-element imaging detector such that an image of said sample surface produced by said multi-element imaging detector is both substantially in focus, and such that substantially no keystone error is demonstrated in said image.

2. An imaging system for viewing a sample at an inclined angle as in claim 1, which further comprises a computer for receiving data from said multi-element imaging detector and correcting it for image aspect ratio.

3. An imaging system for viewing a sample at an inclined angle as in claim 1, which further comprises at least one polarizer between said source of illuminating electromagnetic radiation and said multi-element imaging detector to enable effecting a polarization state in said illuminating electromagnetic radiation produced by said source thereof.

4. An imaging system for viewing a sample at an inclined angle as in claim 3, which further comprises at least one compensator between said source of illuminating electromagnetic radiation and said multi-element imaging detector to enable effecting a polarization state in said illuminating electromagnetic radiation produced by said source thereof.

5. An imaging system for viewing a sample at an inclined angle as in claim 1, in which said telecentric lens system comprises in sequence:
a lens;
an aperture having a diameter; and
a lens.

6. An imaging system for viewing a sample at an inclined angle as in claim 5, in which said aperture diameter is adjustable.

7. An imaging system for viewing a sample at an inclined angle as in claim 1, which further comprises a second imaging, or metrology, system positioned substantially above said sample surface and between said source of illuminating electromagnetic radiation and said multi-element imaging detector having an input surface.

8. An imaging system for viewing a sample at an inclined angle as in claim 1, in which, during use, illuminating electromagnetic radiation provided by source of illuminating electromagnetic radiation approaches the sample surface along an oblique angle.

9. An imaging system for viewing a sample at an inclined angle as in claim 6, in which the oblique angle of said illuminating electromagnetic radiation is at, or near the Brewster angle for the sample being investigated.

10. A system comprising an imaging system for viewing a sample at an inclined angle, in functional combination with a reflectometer, spectrophotometer, ellipsometer or polarimeter system;
said imaging system for viewing a sample at an inclined angle, comprising:
a) a source of illuminating electromagnetic radiation;
b) a stage for supporting a sample placed thereupon;
c) a telecentric lens system; and
d) a multi-element imaging detector having an input surface;
said stage and multi-element imaging detector being oriented with respect to one another such that the surface of said sample placed on said stage and the input surface of said multi-element imaging detector meet the Scheimpflug condition, and said telecentric lens system is simultaneously positioned between said sample surface and the input surface of said multi-element imaging detector such that an image of said sample surface produced by said multi-element imaging detector is both substantially in focus, and such that substantially no keystone error is demonstrated in said image;
such that in use said source of illuminating electromagnetic radiation provides illumination to a spot on a sample placed on said stage for supporting a sample placed thereupon;
said reflectometer, spectrophotometer, ellipsometer or polarimeter system comprising:
a source of a sample investigating beam of electromagnetic radiation;
a stage for supporting a sample placed thereupon; and
a detector;
said reflectometer, spectrophotometer, ellipsometer or polarimeter system being oriented to provide a sample investigating beam of electromagnetic radiation to said sample placed on said stage for supporting a sample so that it impinges on a spot thereof which is substantially coincident with illuminating electromagnetic radiation provided by said source of illuminating electromagnetic radiation.

11. A system as in claim 10, which further comprises a computer for receiving data from said multi-element imaging detector and correcting it for image aspect ratio.

12. A system as in claim 10, which further comprises at least one polarizer between said source of illuminating electromagnetic radiation and said multi-element imaging detector to enable effecting a polarization state in said illuminating electromagnetic radiation produced by said source thereof.

13. A system as in claim 12, which further comprises at least one compensator between said source of illuminating electromagnetic radiation and said multi-element imaging detector to enable effecting a polarization state in a beam of electromagnetic radiation produced by said source thereof.

14. A system as in claim 10, in which said telecentric lens system comprises in sequence:
a lens;
an aperture having a diameter; and
a lens.

15. A system for viewing a sample at an inclined angle as in claim 14, in which said aperture diameter is adjustable.

16. A system for viewing a sample at an inclined angle as in claim 10, which further comprises a second imaging, or metrology, system positioned substantially above said sample surface and between said source of a beam of electromagnetic radiation and said multi-element imaging detector having an input surface.

17. A system for viewing a sample at an inclined angle as in claim 10, in which, during use, a illuminating electromagnetic radiation provided by source of a beam of electromagnetic radiation approaches the sample surface along an oblique angle.

18. A system for viewing a sample at an inclined angle as in claim 8, in which the oblique angle of said illuminating electromagnetic radiation is at, or near the Brewster angle for the sample being investigated.

19. A method of investigating a sample with an electromagnetic beam comprising the steps of:
providing an imaging system for viewing a sample at an inclined angle comprising:
a) a source of illuminating electromagnetic radiation;
b) a stage for supporting a sample placed thereupon;
c) a telecentric lens system; and
d) a multi-element imaging detector having an input surface;
said stage and multi-element imaging detector being oriented with respect to one another such that the surface of said sample placed on said stage and the input surface of said multi-element imaging detector meet the Scheimpflug condition, and said telecentric lens system is simultaneously positioned between said sample surface and the input surface of said multi-element imaging detector such that an image of said sample surface produced by said multi-element imaging detector is both substantially in focus, and such that substantially no keystone error is demonstrated in said image;
said method further comprising:
b) orienting said sample surface and multi-element imaging detector surface to meet the Scheimpflug condition and positioning said telecentric lens system between said sample surface and multi-element imaging detector surface so that, in an image of said sample surface when produced by said multi-element imaging detector, demonstrates substantially no keystone error and said image is substantially in focus over its entire extent;
c) causing said source of illuminating electromagnetic radiation to direct illuminating electromagnetic radiation to reflect from said sample surface, pass through said telecentric lens system and enter said multi-element imaging detector;
d) causing said multi-element imaging detector to produce an image of said sample surface that is substantially free of keystone error and is substantially in focus.

20. A method as in claim 19 in which a reflectometer, spectrophotometer, ellipsometer or polarimeter system comprising:
a source of a sample investigating beam of electromagnetic radiation;
a stage for supporting a sample placed thereupon; and
a detector of said sample investigating beam of electromagnetic radiation;
is further provided and in which steps e) and f) are further practiced, said steps e) and f) being;
e) while, or after practicing steps c) and d) to provide an image of said sample surface, causing said source of a sample investigating beam of electromagnetic radiation to direct a sample investigating beam of electromagnetic radiation toward said sample such that it passes through said polarizer, impinges on said sample at a location substantially coincident with said illuminating electromagnetic radiation provided by said source of illuminating electromagnetic radiation, reflects therefrom, passes through said analyzer; and
f) said detector of said sample investigating beam of electromagnetic radiation receiving the sample investigating electromagnetic radiation reflected from said sample, and producing sample characterizing data.

21. A system as in claim 10, in which:
said source of illuminating electromagnetic radiation; and
said source of a sample investigating beam of electromagnetic radiation;
are derived from a single primary source via a beam splitter.

22. A method as in claim 19, in which:
said source of illuminating electromagnetic radiation; and
said source of a sample investigating beam of electromagnetic radiation;
are derived from a single primary source via a beam splitter.

23. A method as in claim 19 in which all method steps are carried out under control of a computer and/or the method includes storing at least some output provided by the detector in a non-transitory maching readable media and analyzing at least some output provided by the detector.
